(19) United States
(12) Patent Application Publication
(10) Pub. No.: US 2026/0349813 A1
(43) Pub. Date: Nov. 5, 2026

(54) MATRIX ELEMENT DATA CONVERSION FOR TENSOR OPERATION SUPPORT

(71) Applicant: ADVANCED MICRO DEVICES, INC., Santa Clara, CA (US)

(72) Inventors: Bin He, Orlando, FL (US); Shubra Marwaha, Santa Clara, CA (US); Subramaniam Maiyuran, Folsom, CA (US); Ashutosh Garg, Folsom, CA (US)

(21) Appl. No.: 19/198,775

(22) Filed: May 5, 2025

(51) Int. Cl. G06F 9/50; G06F 5/01; G06F 17/16

(52) U.S. Cl. CPC G06F 9/5027; G06F 5/012; G06F 17/16

(57) ABSTRACT

A processing system includes an accelerator unit (AU) configured to perform matrix multiplication operations and subsequent tensor operations for a machine-learning model implemented by the processing system. When performing the matrix multiplication operations, the AU uses matrices having values in a first data format to generate result matrices also having values in the first data format. Further, to perform a subsequent tensor operation, the AU scales and rounds one or more of the values of the result matrix in the first data format such that the values are converted to a second, lower-precision format. The AU then performs the tensor operation using the values in the second, lower-precision format.

### BACKGROUND

To implement certain machine-learning models, some processing systems include specialized processing units, such as graphics processing units (GPUs), that perform dot-product operations using matrices representing the weights and biases of the machine-learning models. After performing these dot-product operations, the specialized processing units produce resulting matrices having elements that store values in a first data format. The specialized processing units then perform various tensor operations for the machine-learning model using the values stored in the elements of the matrices resulting from the dot-product operations. However, certain conditions arise where the specialized processing units do not support using values in this first data format when performing certain tensor operations. Because the specialized processing units do not support values in this data format for these tensor operations, the specialized processor units are limited to using data formats that are supported for these tensor operations when performing dot-product operations for the machine-learning model, limiting the precision of these dot-product operations and the accuracy of the machine-learning model.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to covert values used in tensor operations of a machine-learning model from a first data format to a second, less precise data format, in accordance with embodiments.

FIG. 2 is a block diagram of an example process for converting values of matrix elements from a first data format to a second, less precise data format, in accordance with embodiments.

FIG. 3 is a block diagram of an example stochastic rounding operation for a scaled number, in accordance with embodiments.

FIG. 4 is a block diagram of an example process for converting values of matrix elements from a first data format to a second, more precise data format, in accordance with embodiments.

FIGS. 5 and 6 together present an example method for converting values of matrix elements from a first data format to a second, less precise data format, in accordance with some embodiments.

FIG. 7 is a block diagram of an example method for converting values of matrix elements from a first data format to a second, more precise data format, in accordance with embodiments.

### DETAILED DESCRIPTION

Systems and techniques disclosed herein include a processing system configured to implement one or more machine-learning models. For example, while executing certain applications, the processing system is configured to implement machine-learning models such as supervised machine-learning models, unsupervised machine-learning models, reinforcement machine-learning models, neural networks, deep-learning neural networks, large language models, multimedia large language models, and the like that are configured to generate data for the executing applications. These machine-learning models, for example, require the processing system to perform dot-product operations and various tensor operations using matrices representing weights, biases, scales, and the like of a corresponding machine-learning model. Such tensor operations include, for example, one or more mathematical operations such as addition operations, subtraction operations, inversion operations, division operations, multiplication operations, and the like. To perform these dot-product and tensor operations for a machine-learning model, the processing system includes an accelerator unit (AU) that includes one or more processor cores that each operate as one or more compute units. A compute unit, for example, includes one or more single instruction, multiple data (SIMD) units having arithmetic logic unit (ALU) circuitry that includes one or more ALUs configured to perform dot-product and tensor operations using data stored in vector registers included in or otherwise connected to the SIMD unit, hardware buffers of the AU, or both. As an example, when implementing a machine-learning model, an AU is configured to first perform one or more dot-product operations with matrices that include elements storing values representing weights, biases, scales, and the like of the machine-learning model to produce one or more result matrices. The AU then performs one or more tensor operations using values stored in elements of the result matrices so as to implement the machine-learning model. To help improve the accuracy of the implemented machine-learning model, the values stored in the matrices used in and resulting from the dot-product operations are in a high-precision data format such as, for example, a floating point data format like floating point (FP) 32, FP 64, or the like.

However, the AU may not support these high-precision formats for values used in one or more of the subsequent tensor operations. As such, the AU is configured to convert the values of one or more elements of the result matrices from a first high-precision data format to a second lower-precision data format such as FP4, FP6, FP8 and the like that is supported for one or more tensor operations. As an example, to convert the value of an element of a result matrix from a first, high-precision format (e.g., FP 64, FP 32, FP16, brain floating point (BF) 16) to a second, lower-precision format (e.g., FP4, FP6, FP8), the AU first determines whether the value indicates a number or a non- number value type such as number (NaN), infinity (INF), or the like. In response to the value indicating a non-number value type, the AU outputs a predetermined value in the second data type as the converted value (e.g., value converted to the second data type). As an example, in response to the value indicating a non-number value type, the AU outputs the maximum number representable by the second data format (e.g., FLT_MAX), NaN, or INF as the converted value based on the values supported by the second data format. If the value does indicate a number, the AU determines whether that number is a denormalized number (e.g., a number having a most significant mantissa bit of zero). The AU then, based on the value indicating a denormalized value, determines whether denormalized values are to be maintained when converting values from the first data format to the second lower-precision data format. As an example, the AU checks one or more stored flags, values, or both indicating whether denormalized values are to be maintained for corresponding conversions between data types. In response to one or more corresponding flags, values, or both indicating that denormalized values are not to be maintained, the AU flushes the value and outputs zero in the second data format as the converted value.

Further, in response to one or more corresponding flags, values, or both indicating that denormalized values are to be maintained, the AU converts the denormalized number indicated by the value to a normalized number (e.g., a number having a most significant mantissa bit of one). For example, the AU first identifies a bit indicating one in the denormalized number and shifts this identified bit such that the number is in a normalized form. The AU then adjusts one or more exponents of the number based on a predetermined adjustment value. Additionally, in response to the value indicating a normalized number or after converting the denormalized number indicated by the value to a normalized form, the AU scales this normalized number to produce a scaled number. For example, the AU divides the normalized number by a predetermined scale that represents a predetermined mantissa value with an unbiased exponent. After scaling the number, the AU determines whether to clamp or round the scaled number to ensure that the scaled number falls within the range of numbers representable by the second data format. As an example, if the scaled number is greater than the highest number representable by the second data format, the AU clamps the scaled number to the highest number representable in the second data format or INF in the second data format based on the value types supported by the second data format.

Further, in response to the scaled number being less than the lowest subnormal number representable by the second data format, the AU clamps the scaled number to zero in the second data format. As another example, the AU, based on the scaled number being equal to or less than a maximum subnormal number representable by the second data format and being equal to or greater than the minimum subnormal number representable by the second data format (e.g., being within the subnormal range of the second data format), the AU shifts the mantissa bit of the sealed number based on an exponent difference so as to convert the scaled number into a denormalized form. The AU then rounds this denormalized number using a Round Nearest, ties to Even (RNE) operation, a stochastic rounding operation, or the like to produce a converted value. Additionally, in response to the scaled number being greater than or equal to the lowest normal number representable by the second data format and being less than or equal to the greatest normal number representable by the second data format, the AU rounds the scaled number using an RNE operation, stochastic rounding operation, or the like to produce a converted value. After producing a converted value for an element of a result matrix to be used in one or more tensor operations, the AU then converts the value of a next element of the result matrix that is to be used for the tensor operations. The AU then continues in this way until all the values needed for the tensor operations are converted to the second data format and performs the tensor operations. As such, the AU is enabled to improve the accuracy of the machine-learning model through the use of higher-precision format values during the dot-product operations while still being able to perform subsequent tensor operations by converting the values to lower-precision data formats.

Further, the AU is configured to convert values of matrix elements in a lower-precision data format, such as those used in some tensor operations, to a higher-precision data format for use in dot-product operations, other tensor operations, or both. As an example, to convert the value of a matrix element from a first data format (e.g., FP4, FP6, FP8) to a third, higher-precision data format (e.g., BF16, FP 16, FP 32, FP64), the AU first determines whether the value indicates a value type other than a number such as NaN or INF. In response to the value indicating a non-number value type, the AU outputs the maximum representable number, NaN, or INF in the third data format as the converted value based on the value types supported by the third data format. If the value does indicate a number, the AU then scales the number by, for example, multiplying the number by the predetermined scale. Further, based on the scaled number being a normalized number within the representable range of the third data format, the AU outputs the scaled number as the converted value. However, if the scaled number is greater than the representable range of the third data format, the AU outputs INF in the third data format as the converted value. Additionally, if the scaled number is a denormalized number, the AU determines whether denormalized values are to be retained when converting values to the third data format. If denormalized values are not to be maintained, the AU flushes the value and outputs zero in the third data format as the converted value. Further, if denormalized values are to be maintained, the AU outputs the scaled denormalized number as the converted value.

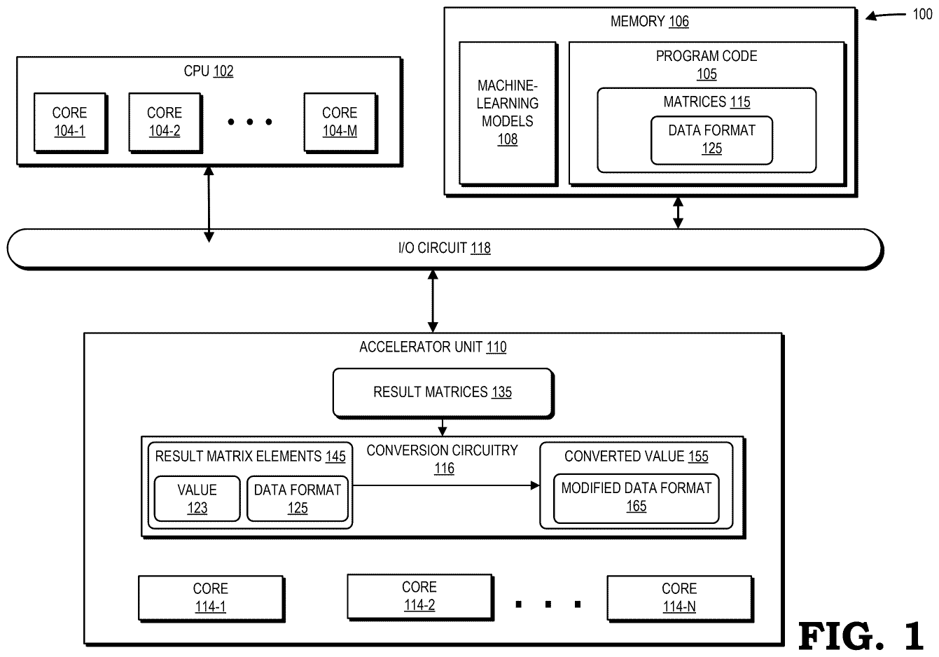

Referring now to FIG. 1, a processing system 100 configured to covert values used in tensor operations of a machine-learning model from a first data format to a second, less precise data format is presented, in accordance with embodiments. According to implementations, processing system 100 is configured to execute applications that require processing system 100 to implement one or more machine-learning models 108 such as one or more supervised machine-learning models, unsupervised machine-learning models, reinforcement machine-learning models, neural networks, deep-learning neural networks, large language models, multimedia large language models, and the like. While implementing a machine-learning model 108, processing system 100 is configured to perform one or more matrix multiplication operations (e.g., dot product operations) using matrices 115 having elements that store values representing the weights, biases, scales, or combination thereof of the machine-learning model so as to produce one or more result matrices 135 (e.g., matrices resulting from the performance of dot-product operations using matrices 115). Processing system 100 then performs one or more tensor operations (e.g., additional operations, subtraction operations, multiplication operations, division operations, inversion operations, and the like) using one or more values 123 stored in the elements of the result matrices 135 (represented in FIG. 1 as result matrix elements 145).

To perform the matrix multiplication and tensor operations for a machine-learning model 108, processing system 100 includes AU 110 which is configured to execute instructions so as to perform one or more matrix multiplication operations, tensor operations, or both for a machine-learning model 108. AU 110 is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. To execute instructions indicating matrix multiplication and tensor operations to be performed, AU 110 implements one or more processor cores 114 that execute instructions concurrently or in parallel. In some implementations, one or more of the processor cores 114 each operate as one or more compute units that each include one or more SIMD units configured to perform matrix multiplication operations. As an example, a SIMD unit includes ALU circuitry configured to perform matrix multiplication operations or tensor operations using data (e.g., matrices 115, values 123) read out of vector registers included in or otherwise connected to the processor core 114 including the SIMD unit. Though the example implementation presented in FIG. 1 shows AU 110 as including three cores (114-1, 114-2, 114-N) representing an N integer number of cores, in other implementations, AU 110 can include any non-zero integer number of processor cores 114 each configured to operating as one or more compute units.

Further, to implement a machine-learning model, processing system 100 includes or otherwise has access to memory 106 that stores program code 105 for the machine-learning model 108. That is to say, memory 106 is configured to store data representing the machine-learning model 108. In some implementations, memory 106 is implemented using a non-transitory computer-readable medium, for example, a dynamic random-access memory (DRAM) while in other implementations, memory 106 is implemented using other types of memory including, for example, static random-access memory (SRAM), nonvolatile RAM, and the like. Additionally, memory 106, according to some implementations, includes an external memory implemented external to the processing units implemented in the processing system 100. Program code 105 includes, for example, compiled code (e.g., compiled binary code) indicating instructions that, when executed, cause the matrix multiplication operations and tensor operations to be performed for a machine-learning model 108. As an example, program code 105 includes instructions that indicate corresponding matrix multiplication operations to be performed using matrices 115, tensor operations to be performed using one or more values 123, or both for a respective machine-learning model 108.

To help improve the accuracy of an implemented machine-learning model 108, AU 110 is configured to perform the matrix multiplication operations for the machine-learning model 108 using matrices 115 that have elements with values in a high-precision data format such as FP 64, FP 32, and the like. However, in certain embodiments, AU 110 does not support performing one or more subsequent tensor operations for the machine-learning model 108 using values 123 in these high-precision data formats. In other words, AU 110 is configured to perform the tensor operations using values in lower-precision data formats. As such to enable AU 110 to perform matrix multiplication operations on matrices 115 having values in a high-precision format and subsequent tensor operations using values 123 from the result matrix elements 145, AU 110 includes conversion circuitry 116 configured to convert the values 123 of the result matrix elements 145 from a high-precision format (e.g., FP 64, FP2) to a lower-precision data format (e.g., F4, FP6, FP8) before performing corresponding tensor operations. That is to say, conversion circuitry 116 is configured to convert the values 123 of one or more result matrix elements 145 from a first data format 125 (e.g., high-precision data format) to a modified data format 165 (e.g., lower-precision data format). Such conversion circuitry 116, for example, includes one or more portions of AU 110 (e.g., processor cores 114, microprocessors, registers, memory).

In embodiments, to convert values 123 of one or more result matrix elements 145 in a first data format 125 to converted values 155 in the modified data format 165, conversion circuitry 116 determines whether the value 123 of a first result matrix element indicates a number or another value type such as NaN, INF, or the like. In response to the value 123 indicating a value type other than a number (e.g., FLT_MAX, NaN, INF), conversion circuitry 116 generates a predetermined value as the converted value 155 based on the modified data format 165 (e.g., based on what value types the modified data format 165 supports) and the value type indicated by the value 123 of the first result matrix element. As an example, in response to the modified data format 165 (e.g., FP4, FP6) not supporting NaN or INF value types and in response to the value 123 of the first result matrix element indicating NaN or INF, conversion circuitry 116 generates a converted value 155 indicating the maximum number representable (e.g., FT_MAX) by the modified data format 165. As another example, in response to the modified data format 165 supporting NaN and INF value types and in response to the value 123 of the first result matrix element indicating NaN or INF, conversion circuitry 116 generates a converted value 155 indicating NaN or INF, respectively, in the modified data format 165.

If the value 123 indicated by the first result matrix element indicates a number, conversion circuitry 116 determines whether the indicated number is a normalized number (e.g., a mantissa number having a lead bit of one) or a denormalized number (e.g., mantissa number having a lead bit of zero). In response to the indicated number being a denormalized number, conversion circuitry 116 either discards or converts the denormalized number to a normalized number based on one or more flags, values, or both associated with the modified data format 165. For example, based on one or more flags, values, or both associated with the modified data format 165 indicating that denormalized numbers are to be maintained, conversion circuitry 116 converts the denormalized number to a normalized number by shifting one or more bits of the number and adjusting one or more exponents by a predetermined amount so as to produce a normalized number. Further, in response to the indicated number being a normalized number or in response to converting a denormalized number to a normalized number, conversion circuitry 116 scales the normalized number by a predetermined amount to produce a scaled number. As an example, conversion circuitry 116 divides the normalized number by a scale that represents a predetermined normalized mantissa number with an unbiased exponent to produce a scaled number.

After generating a scaled number, conversion circuitry 116 then clamps, rounds, or both the scaled number to ensure that the scaled number falls within the representable number range of the modified data format 165. For example, if the scaled number is greater than the maximum number representable by (e.g., the maximum magnitude of) the modified data format 165, conversion circuitry 116 outputs the maximum number representable by (e.g., FLT_MAX) of the modified data format 165 or INF in the modified data format 165 as the converted value 155 based on the value types supported by the modified data format 165. As another example, in response to the scaled number being less than the minimum subnormal number representable by the modified data format 165 (e.g., min subnorm), conversion circuitry 116 outputs zero in the modified data format 165 as the converted value 155. As yet another example, if the scaled number is equal to or less than the maximum subnormal number representable by the modified data format 165 (e.g., max subnorm) and greater than or equal to the minimum subnormal number representable by the modified data format 145, conversion circuitry 116 converts the scaled number to a denormalized number by shifting the bits of the scaled number and then rounds this denormalized number using an RNE operation, stochastic rounding operation, or both to produce the converted value 155. Additionally, if the scaled number is equal to or greater than the minimum normal number representable by the modified data format 165 and less than or equal to the maximum value representable by the modified data format 165, conversion circuitry 116 rounds the scaled number using an RNE operation, stochastic rounding operation, or both to produce the converted value 155. Such a stochastic rounding operation includes, for example, conversion circuitry 116 randomly generating (e.g., based on a random variable or pseudo-random variable) a stochastic number in the first data format 125, aligning the stochastic number with the number to be rounded (e.g., scaled number, denormalized number), adding the stochastic number to the number, and then truncating the combined number to produce the converted value 155 in the modified data format 165.

After generating a converted value 155 for a first result matrix element, conversion circuitry 116 moves to the next result matrix element to be used in a tensor operation and converts the value 123 of that element from the first data format 125 to the modified data format 165. conversion circuitry 116 then continues in this way until all the values 123 of result matrix elements 145 to be used in the tensor operations are converted from the first data format 125 to the modified data format 165. AU 110 then performs the tensor operations using the converted values 155. As such, by converting the values 123 of the result matrix elements 145 used by the tensor operations, AU 110 is enabled to use higher precision data formats when performing the matrix multiplication operations which improves the accuracy of the machine-learning model 108.

In some embodiments, conversion circuitry 116 is configured to convert one or more values from a data format (e.g., FP4, FP6, FP8) to a third higher-precision data format (BF16, FP16, FP32, FP64). As an example, conversion circuitry 116 is configured to convert one or more converted values 155 used in a tensor operation to a third, higher-precision data format for use in one or more additional tensor operations, matrix multiplication operations, or both. In embodiments, to convert a value (e.g., converted value 155) to this third higher-precision data format, conversion circuitry 116 first determines whether the value indicates a number or another value type such as INF or NaN. In response to the value indicating another value type such as INF or NaN, conversion circuitry 116 outputs the maximum representable number of the third data format or a predetermined converted value type (e.g., INF, NaN) in the third data format as the converted value based on the value types supported by the third data format. Further, in response to the value indicating zero, conversion circuitry 116 outputs a zero in the third data format as the converted value. If the value indicates a number, conversion circuitry 116 descales the number by a predetermined scale by, for example, multiplying the number by the scale (e.g., a predetermined mantissa number with an unbiased exponent). Additionally, conversion circuitry 116, based on the descaled number being in a normalized number range of the third data format, outputs the descaled number as the converted value. If, however, the descaled number is greater than the maximum representable number of the second data format, conversion circuitry 116 outputs an INF data type in the third data format as the converted value. Further, in response to the descaled number being in a subnormal number range of the third data format, conversion circuitry 116 outputs the descaled number as the converted value or discards the descaled number based on one or more settings of the second data type (e.g., whether denormalized numbers are to be retained).

According to embodiments, processing system 100 includes CPU 102 configured to provide an instruction stream indicating matrix multiplication operations and tensor operations to AU 110. As an example, in implementations, CPU 102 is configured to maintain a command queue (e.g., a circular queue) that stores a set of instructions indicating one or more matrix multiplication operations and tensor operations. After the command queue is ready to be consumed, AU 110 retrieves the set of instructions for the command queue which forms the instruction stream provided to AU 110. To maintain this command queue, CPU 102 includes one or more processor cores 104 that implement a plurality of processor cores 104-1 to 104-M configured to execute instructions concurrently or in parallel. Though in the example implementation illustrated in FIG. 1, three processor cores (104-1, 104-2, 104-M) are presented representing an M integer number of cores, the number of processor cores 104 implemented in the CPU 102 is a matter of design choice. As such, in other implementations, the CPU 102 can include any non-zero integer number of processor cores 104. In some implementations, to enable communication between CPU 102 and one or more other components (e.g., AU 110, memory 106) of processing system 100, processing system 100 includes input/output (I/O) circuit 118. I/O circuit 118 includes, for example, one or more busses, memory controllers, switches (e.g., PCI switches), data fabrics, queues, buffers, and the like. As an example, I/O circuit 118 is configured to connect a command processor of AU 110 to one or more processor cores 104 of CPU 102, memory 106, or both.

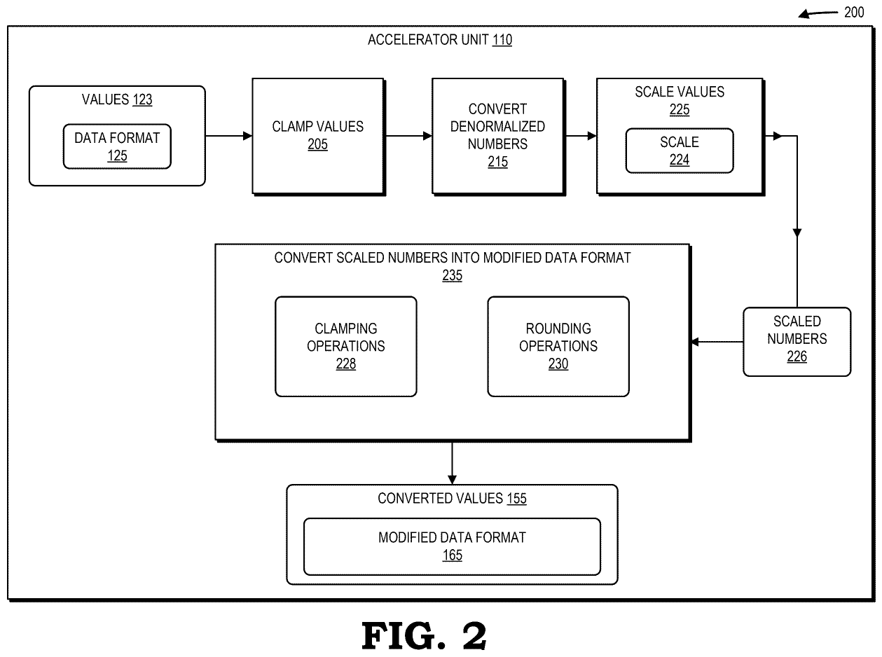

Referring now to FIG. 2, an example process 200 for converting values of matrix elements from a first data format to a second, less precise data format is presented, in accordance with embodiments. In embodiments, example process 200 is implemented at least in part by AU 110 (e.g., one or more processor cores 114 of AU 110). Example operation 200 includes AU 110 converting the values 123 of one or more result matrix elements 145 in a first data format 125 (e.g., high-precision data format) to corresponding converted values 155 in a modified data format 165 (e.g., lower-precision data format). For example, AU 110, at block 205 of example process 200, is configured to clamp the values 123 of one or more result matrix elements 145 to respective predetermined values based on the values 123 indicating a non-number value type such NaN, INF, or the like. That is to say, AU 110 clamps the non-number value of a result matrix element 145 to a predetermined value in the modified data format 165 based on the value type indicated by the non-number value, the value types supported by the modified data format 165, or both. As an example, AU 110 clamps a value 123 indicating NaN or INF in the first data format 125 to a NaN or INF, respectively, in the modified data format 165 based on the modified data format supporting NaN or INF value types, respectively. As another example, AU 110 clamps a value 123 indicating NaN or INF in the first data format 125 to the maximum representable number in the modified data format 165 based on the modified data format 165 (e.g., F4, F6) not supporting NaN or INF value types, respectively. After clamping the non-number value to a predetermined value in the modified data format 165, AU 110 outputs this predetermined value as the converted value 155.

Additionally, example process 200 includes, at block 215, AU 110 converting the values 123 of the result matrix elements 145 indicating denormalized numbers to a normalized form. As an example, at block 215, AU 110 first determines whether denormalized values are to be retained for the modified data format 165. That is to say, AU 110 checks one or more flags, values, or both stored in memory 106 indicating whether denormalized values are to be retained for the modified data format 165. In response to one or more flags, values, or both indicating that denormalized numbers are not to be maintained for the modified data format 165, AU 110 discards the values 123 indicating denormalized numbers by flushing these values 123 and outputting zero in the modified data format 165 as the converted value 155. Further, in response to one or more flags, values, or both indicating that denormalized numbers are to be maintained, AU 110 converts the denormalized numbers indicated by the values 123 by identifying a leading one bit within a denormalized number, shifting the identified one bit such that the number is in a normalized form (e.g., a mantissa number having a one in the lead bit), and adjusting the exponents of the number by a predetermined amount (e.g., −126-predetermined_amount). At block 225, AU 110 is configured to scale one or more values 123 indicating normalized numbers, normalized numbers converted from denormalized numbers at block 215, or both. To scale these normalized numbers, AU 110 first divides a normalized number by a predetermined scale 224. Such normalized numbers, for example, are represented by mantissa numbers with a leading bit of one and a biased exponent (e.g., S1.xxx*2^{y}), and such predetermined scales 224, for example, are represented by a predetermined mantissa number with a leading bit of one and an unbiased exponent (e.g., S1.0000*2^{z}). After dividing a normalized number by the predetermined scale 224, AU 110 produces a scaled number 226 represented, for example, by a normalized mantissa number (e.g., S1.xxx*2^{(y-z)}).

In response to generating one or more scaled numbers 226, at block 235, AU 110 is configured to perform one or more clamping operations 228, rounding operations 230, or both to ensure that the scaled numbers 226 are representable in the modified data format 165. For example, at block 235, AU 110 first performs one or more clamping operations 228 that include clamping one or more scaled numbers 226 greater than the maximum representable number of the modified data format 165 to a predetermined value in the modified data format 165 based on the value types supported by the modified data format 165. As an example, AU 110 clamps one or more scaled numbers 226 greater than the maximum representable number of the modified data format 165 to a number representing the maximum representable number of the modified data format 165 (e.g., FLT_MAX), a NaN value, or an INF value based on the value types supported by the modified data format 165. AU 110 then outputs this value as the converted value 155. In some embodiments, for example, AU 110 clamps one or more scaled numbers 226 greater than the maximum representable number of the modified data format 165 to a number representing the maximum representable number of the modified data format 165 based on the modified data format 165 not supporting NaN value types, INF value types, or both. As another example, at block 235, AU 110 performs a clamping operation 228 that includes clamping one or more scaled numbers 226 less than a minimum subnormal number representable by the modified data format 165 to zero in the modified data format 165 and outputs this zero in the modified data format 165 as the converted value 155.

Further, at block 235, AU 110 is configured to perform one or more rounding operations 230 that include converting scaled numbers 226 equal to or less than the maximum subnormal number representable by the modified data format 165 and equal to or greater than the minimum subnormal number representable by the modified data format 165 to a denormalized form. For example, in response to a scaled number 226 being equal to or less than the maximum subnormal number representable by the modified data format 165 and equal to or greater than the minimum subnormal number representable by the modified data format 165 (e.g., being within the subnormal number range of the modified data format 165), AU 110 shifts the lead one bit of the scaled number 226 based on an exponent difference of the number such that the scaled number 226 is in a denormalized form. Additionally, at block 235, AU 110 is configured to perform one or more rounding operations 230 that include rounding scaled numbers 226 that are equal to or greater than the minimum normal number representable by the modified data format 165 and equal to or less than the maximum normal number representable by the modified data format 165 (within the normal number range of the modified data format 165), scaled numbers 226 converted to a denormalized form, or both by performing one or more RNE operations, stochastic rounding operation, or both. After rounding such scaled numbers 226, AU 110 outputs the rounded scaled numbers as the corresponding converted values 155.

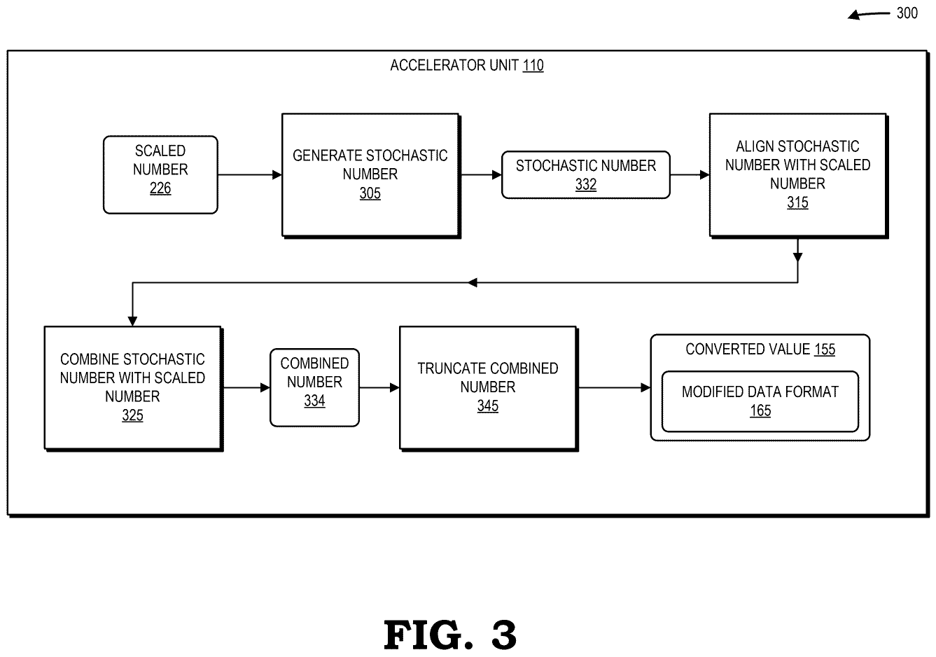

Referring now to FIG. 3, an example stochastic rounding operation 300 for a scaled number is presented, in accordance with embodiments. In embodiments, example stochastic rounding operation 300 is performed at least in part by AU 110 (e.g., one or more processor cores 114 of AU 110). For example, example stochastic rounding operation 300 is performed at least in part by AU 110 during example process 200 so as to round one or more scaled numbers 226. To round a scaled number 226, example stochastic rounding operation 300 includes, at block 305, AU 110 randomly (e.g., based on a random or pseudo-random number) generating a stochastic number 332 that has a number of bits corresponding to the first data format 125 of the scaled number 226 to be rounded. As an example, the stochastic number 332 has 32 bits based on the scaled number 226 having an FP32 data format. In embodiments, AU 110 is configured to randomly generate a corresponding stochastic number 332 for each scaled number 226 to be rounded using example stochastic rounding operation 300. At block 315, AU 110 aligns the stochastic number 332 with the scaled number 226 and, at block 325, combines the aligned stochastic number 332 with the scaled number 226 to produce a combined number 334. For example, AU 110 adds the aligned stochastic number 332 to the scaled number 226 to produce the combined number 334. After producing a combined number 334, at block 345, AU 110 truncates the combined number 334 such that the combined number 334 has a number of bits corresponding to the modified data format 165 (e.g., the data format to which the scaled number 226 is to be converted). As an example, AU 110 truncates combined number 334 to have 8 bits based on converting the scaled number 226 to FP8. AU 110 then outputs the truncated number as the converted value 155.

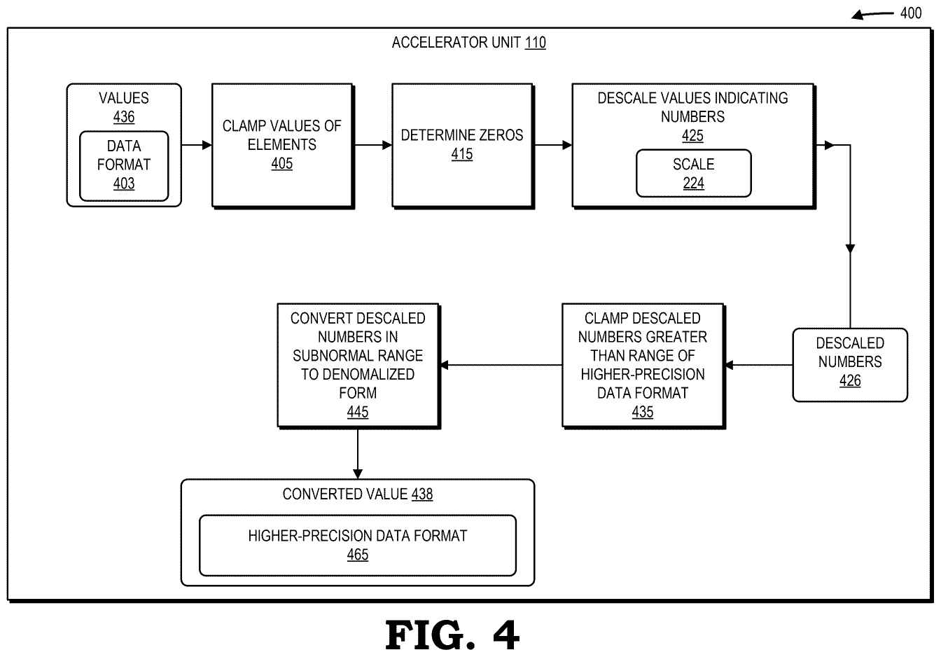

Referring now to FIG. 4, an example process 400 for converting values from a first data format to a second, more precise data format is presented, in accordance with embodiments. In embodiments, example process 400 is implemented at least in part by AU 110 (e.g., one or more processor cores 114 of AU 110). Example operation 400 includes AU 110 converting one or more values 436 (e.g., converted values 155) in a first data format 403 (e.g., FP4, FP6, FP8) to corresponding converted values 438 in a higher- precision data format 465 (e.g., FP32, FP64). For example, AU 110, at block 405 of example process 400, first clamps one or more values 436 having a non-number value-type (e.g., NaN, INF) to a corresponding value in the higher-precision data format 465. For example, in response to a value 436 indicating an NaN or INF data type, AU 110 clamps the value to NaN or INF, respectively, in the higher-precision data format 465 to produce the converted value 438. Further, at block 415, AU 110 is configured to determine one or more values 436 to be converted that indicate a zero in the first data format 403. AU 110 then, for the values 436 indicating a zero in the first data format 403, outputs a zero in the higher-precision data format 465 as the converted value 438.

For the values 436 to be converted indicating a normalized or denormalized number, at block 425, AU 110 is configured to descale the normalized or denormalized numbers using the predetermined scale 224. For example, AU 110 multiplies the values 436 indicating normalized or denormalized numbers by the predetermined scale 224 to produce descaled numbers 426 each represented by a corresponding mantissa number (e.g., Sx.xxx*2^{(y+z)}) having a number of bits corresponding to the higher-precision data format 465. After generating one or more descaled numbers 426, at block 435, AU 110 clamps the descaled numbers 426 indicating numbers greater (e.g., having exponents greater than) than the maximum number representable by the higher-precision data format 465 to the maximum number representable by the higher-precision data format 465 and outputs this the maximum number representable by the higher-precision data format 465 as the corresponding converted values 438. Additionally, at block 445, AU 110 checks one or more flags, values, or both to determine whether denormalized values are to be retained for the higher-precision data format 465. In response to denormalized numbers not being retained for the higher-precision data format 465, AU 110 flushes the descaled numbers 426 indicating numbers in (e.g., having exponents in) the denormalized range of the higher-precision data format 465 and outputs zero in the higher-precision data format 465 as the corresponding converted values 438. Further, in response to denormalized numbers being retained for the higher-precision data format 465, AU 110 converts the descaled numbers 426 indicating numbers in the denormalized range of the higher-precision data format 465 into a denormalized form by shifting one or more bits (e.g., a one bit) based on an exponent difference. AU 110 then outputs the converted denormalized numbers as the converted values 438. Further, AU 110 outputs the descaled numbers 426 not clamped at block 435 or converted at block 445 as corresponding converted values 438.

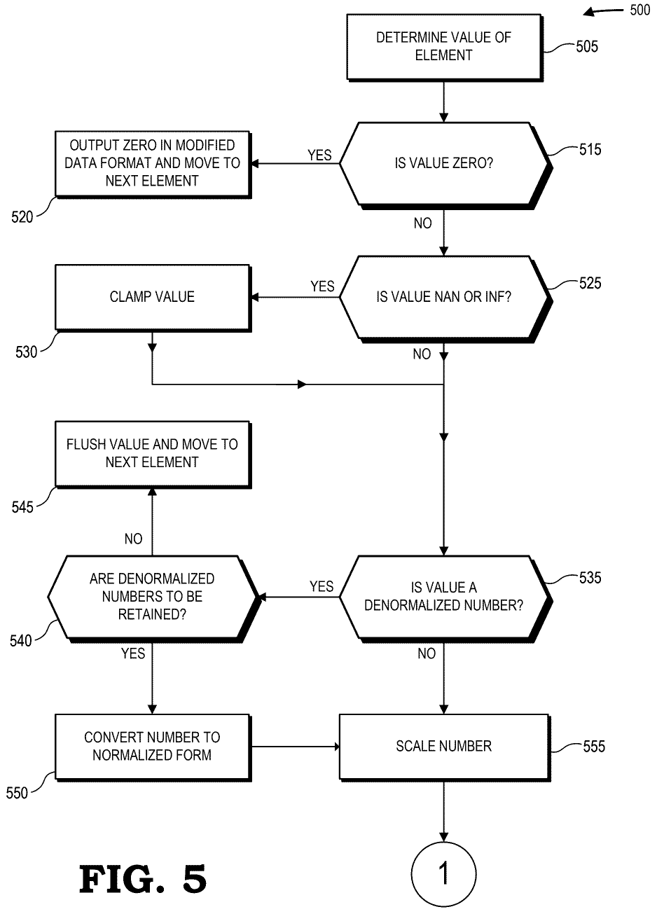

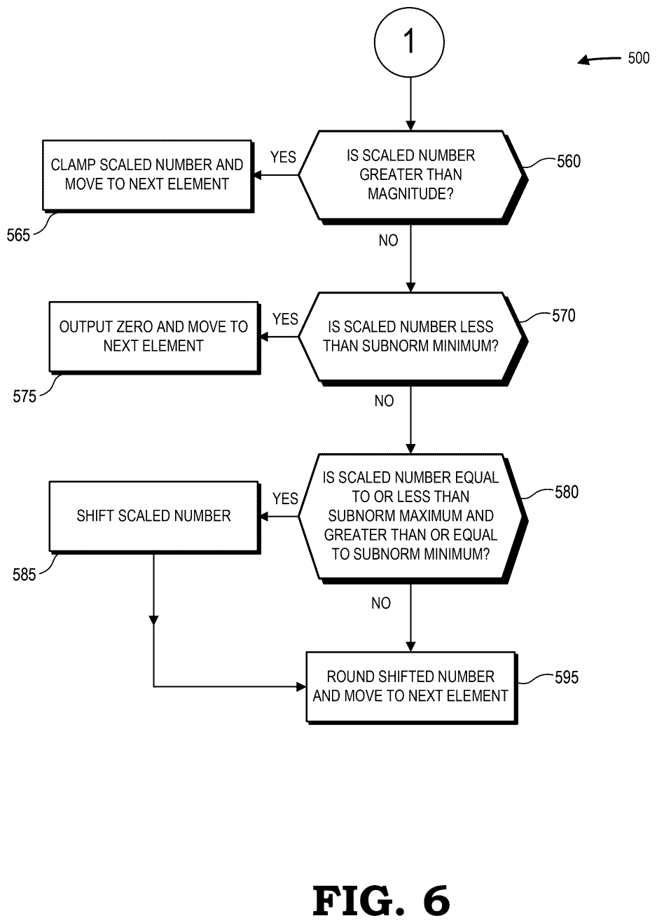

Referring now to FIGS. 5 and 6, an example method 500 for converting values of matrix elements from a first data format to a second, less precise data format is together presented by FIGS. 5 and 6, in accordance with embodiments. In embodiments, example method 500 is implemented at least in part by AU 110, such as by one or more processor cores 114 of AU 110, to convert the values 123 of one or more result matrix elements 145 from a first data format 125 to a modified data format 165 representing a higher-precision data format. Referring now to FIG. 5, example method 500 includes, at block 505, AU 110 determining the value 123 indicated by a result matrix element 145 in a first data format 125. At block 515, AU 110 determines whether the determined value 123 represents a zero in the first data format 125 and, in response to the determined value 123 representing a zero in the first data format 125, at block 520, outputs a zero in the modified data format 165 as the converted value 155. AU 110 then moves to a next result matrix element 145 and repeats block 505. Referring again to block 515, in response to the determined value 123 not representing a zero in the first data format 125, AU 110, at block 525, determines whether the value 123 indicates a non-number value type in the first data format 125 such as NaN, INF, or the like. Based on the value 123 indicating a non-number value type, at block 530, AU 110 clamps the value 123 to a predetermined value in the modified data format 165 based on the non-number value type of the value 123 and the value types supported by the modified data format 165. As an example, AU 110 clamps a value indicating NaN or INF in the first data format 125 to the maximum number representable by the modified data format 165 based on NaN, INF, or both not being supported by the modified data format 165. As another example, AU 110 converts a value indicating NaN or INF in the first data format 125 to NaN or INF, respectively, in the modified data format 165 based on NaN, INF, or both being supported by the modified data format 165. After clamping the value 123 in this way, AU 110 outputs the clamped value as the converted value 155, moves to a next result matrix element 145, and repeats block 505.

Referring again to block 525, in response to the value 123 indicating a number (e.g., not indicating a non-number type), AU 110, at block 535 determines whether the value 123 indicates a denormalized number representing, for example, a subnormal range of the first data format 125. In response to the value indicating a denormalized number, at block 540, AU 110 determines whether denormalized numbers are to be retained for the modified data format 165 based on one or more flags, values, or both in memory 106. AU 110, based on denormalized number not being retained for the modified data format 165, at block 545, flushes the value 123 and outputs a zero in the modified data format 165 as the converted value 155. AU 110 then moves to a next result matrix element 145 and repeats block 505. Referring again to block 540, in response to demoralized numbers being retained for the modified data format 165, AU 110, at block 550 converts the denormalized number to a normalized form. For example, AU 110 first identifies a one bit in the denormalized number and shifts the bits of the denormalized number so that the identified one bit is the leading bit. Further, AU 110 adjusts one or more exponents of the denormalized number based on a predetermined value. At block 555, in response to the value 123 being a normalized number or after converting the value 123 to a normalized form, AU 110 scales the normalized number based on a predetermined scale 224 to produce a scaled number 226. As an example, AU 110 divides the normalized number by the predetermined scale 224 to produce the scaled number 226.

Referring now to FIG. 6, after producing a scaled number 226, AU 110, at block 560, determines whether the scaled number 226 is greater than the maximum number representable by the modified data format 165 (e.g., greater than a magnitude of the modified data format 165). If the scaled number 226 is greater than the maximum number representable by the modified data format 165, at block 565, AU 110 clamps the scaled number 226 to a predetermined value based on the value types supported by the modified data format 165. As an example, in response to a scaled number 226 being greater than the maximum number representable by the modified data format 165, AU 110 clamps the scaled number 226 to the maximum number representable by the modified data format 165 based on the modified data format 165 not supporting NaN, INF, or both. As another example, in response to a scaled number 226 being greater than the maximum number representable by the modified data format 165, AU 110 clamps the scaled number 226 to NaN or INF in the modified data format 165 based on the modified data format 165 supporting NaN, INF, or both. AU 110 then outputs the clamped value as the converted value 155, moves to a next result matrix element, and repeats block 505. Referring again to block 560, in response to the scaled number 226 not being greater than (e.g., being equal to or less than) then the maximum number representable by the modified data format 165, at block 570, AU 110 determines whether the scaled number 226 is less than the minimum subnormal number representable by the modified data format 165. At block 575, AU 110, based on the scaled number 226 being less than the minimum subnormal number representable by the modified data format 165, outputs a zero in the modified data format 165 as the converted value 155. AU 110 then moves to a next result matrix element 145 and repeats block 505.

Referring again to block 570, in response to the scaled number 226 not being less than (e.g., being equal to or greater than) the minimum number representable by the modified data format 165, at block 580, AU 110 determines whether the scaled number 226 is equal to or less than the maximum subnormal number representable by the modified data format 165 and equal to or greater than the minimum subnormal number representable by the modified data format 165. That is to say, AU 110 determines whether the scaled number 226 is in the subnormal number range of the modified data format 165. In response to the scaled number 226 being in the subnormal number range of the modified data format 165, at block 585, AU 110 converts the scaled number 226 to a denormalized form by shifting the lead bit of the scaled number 226 based on an exponent difference. At block 595, in response to a scaled number 226 not being in a subnormal number range of the modified data format 165 or in response to converting the scaled number 226 to a denormalized form, AU 110 rounds the scaled number 226 using an RNE operation, stochastic rounding operation, or both. For example, AU 110 randomly generates a stochastic number 332, aligns the stochastic number 332 with the scaled number 226, combines the aligned stochastic number 332 with the scaled number 226 to produce a combined number 334, and truncates the combined number 334 to a number of bits corresponding to the modified data format 165. AU 110 then outputs the rounded value as the converted value 155, moves to a next result matrix element 145, and repeats block 505. AU 110 then continues in this way until the value 123 each result matrix element 145 to be converted has been converted to the modified data format 165.

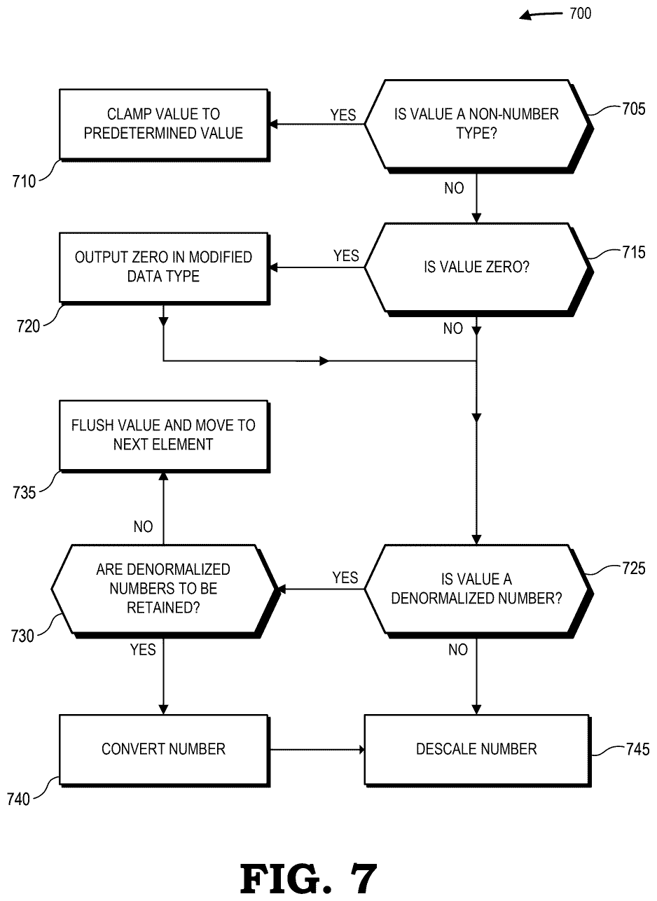

Referring now to FIG. 7, an example method 700 for converting matrix elements from a first data format to a second, more precise data format is presented, in accordance with embodiments. In embodiments, example method 700 is implemented at least in part by AU 110, such as one or more processor cores 114 of AU 110, to convert values 436 in a first data format 403 to converted values 438 in a higher-precision data format 465. Example method 700 includes, at block 705, AU 110 determining whether a value 436 in a first data format 403 indicates a non-number value type such as NaN, INF, or the like. In response to the value 436 indicating a non-number value type, at block 710, AU 110 clamps the value 436 to a predetermined value based on the value types supported by the higher-precision data format 465. As an example, in response to the higher-precision data format 465 supporting NaN, INF, or both, AU 110 clamps a value 436 indicating NaN or INF to NaN or INF, respectively, in the higher-precision data format 465. As another example, in response to the higher-precision data format 465 not supporting NaN, INF, or both, AU 110 clamps a value 436 indicating NaN or INF to the maximum number representable by the higher-precision data format 465. AU 110 then outputs the clamped value as the converted value 438, moves to a next value 436, and repeats block 705. Referring again to block 705, in response to the value 436 not indicating a non-number type (e.g., in response to the value 436 indicating a number), AU 110, at block 715, determines whether the value 436 indicates zero in the first data format 403. If the value 436 indicates zero in the first data format 403, at block 720, AU 110 outputs zero in the higher-precision data format 465 as the converted value 438, moves to a next value 436, and repeats block 705.

Referring again to block 715, in response to the value 436 not indicating zero in the first data format 403, at block 725, AU 110 determines whether the value 436 indicates a denormalized number. Based on the value 436 indicating a denormalized number, AU 110 at block 730, determines whether denormalized numbers are to be retained for the higher-precision data format 465 based one or more flags, values, or both in memory 106. If denormalized numbers are not to be retained for the higher-precision data format 465, at block 735, AU 110 flushes the value 436 and outputs a zero in the higher-precision data format 465 as the converted value 438. AU 110 then moves to a next value 436 and repeats block 705. However, if denormalized numbers are to be retained for the modified data format 165, AU 110, at block 740, converts that number from a denormalized form to a normalized form by, for example, identifying a one bit in the denormalized number and shifting the one bit until the number is in a normalized form. AU 110 then adjusts one or more exponents of the number based on a predetermined number. In response to a value 436 not indicating a denormalized number (e.g., indicating a normalized number) or after converting a value 436 to a normalized number, AU 110, at block 745, descales the value 436 by multiplying the value 436 by a predetermined scale 224 to produce a descaled number 426. AU 110 then outputs this descaled number 426 as the converted value 438, moves to a next value 436, and repeats block 705. AU 110 then continues in this way until all the values 436 to be converted to the modified data format 165 have been converted.

In some embodiments, the apparatus and techniques described above are implemented in a system including one or more integrated circuit (IC) devices (also referred to as integrated circuit packages or microchips), such as the AU 110 described above with reference to FIGS. 1-7. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system, comprising:
a memory configured to store data representing a machine-learning model to be implemented; and
an accelerator unit (AU) coupled to the memory and configured to:
perform one or more matrix multiplication operations of the machine-learning model to produce a result matrix including a plurality of values in a first data format;
applying a predetermined scale to a value of the plurality of values in the first data format to produce a converted value in a second data format lower in precision than the first data format; and
performing a tensor operation of the machine-learning model using the converted value.

2. The processing system of claim 1, wherein the AU does not support the first data format for the tensor operation.

3. The processing system of claim 1, wherein the AU is further configured to:
divide the value by the scale to produce a scaled number; and
round the scaled number to produce the converted value.

4. The processing system of claim 3, wherein the AU is further configured to:
randomly generate a stochastic number;
combine the stochastic number with the scaled number to produce a combined number; and
truncate the combined number to produce the converted value.

5. The processing system of claim 1, wherein the AU is further configured to:
convert the converted value from the second data format to a third data format that is higher in precision than the second data format.

6. The processing system of claim 1, wherein the AU is further configured to:
clamp a second value of the plurality of values to a predetermined value associated with the second data format.

7. The processing system of claim 1, wherein the AU is further configured to:
flush a second value of the plurality of values in response to the second value indicating a denormalized number.

8. A method, comprising:
performing, by an accelerator unit (AU), one or more matrix multiplication operations of a machine-learning model to produce a result matrix including a plurality of values in a first data format;
applying a predetermined scale to a value of the plurality of values in the first data format to produce a converted value in a second data format lower in precision than the first data format; and
performing, by the AU, a tensor operation of the machine-learning model using the converted value.

9. The method of claim 8, wherein the AU does not support the first data format for the tensor operation.

10. The method of claim 8, further comprising:
dividing the value by the scale to produce a scaled number; and
rounding the scaled number to produce the converted value.

11. The method of claim 10, wherein rounding the scaled number comprises:
randomly generating a stochastic number;
combining the stochastic number with the scaled number to produce a combined number; and
truncating the combined number to produce the converted value.

12. The method of claim 8, further comprising:
converting the converted value from the second data format to a third data format that is higher in precision than the second data format.

13. The method of claim 8, further comprising:
clamping a second value of the plurality of values to a predetermined value associated with the second data format.

14. The method of claim 8, further comprising:
flushing a second value of the plurality of values in response to the second value indicating a denormalized number.

15. An accelerator unit (AU), including:
one or more processor cores configured to:
generate, for a machine-learning model, a matrix having a plurality of values in a first floating point data format;
apply a predetermined scale to a value of the plurality of values to produce a scaled number;
rounding the scaled number to produce a converted value in a second floating point data format that is lower in precision than the first floating point data format; and
perform a tensor operation for the machine-learning model using the converted value.

16. The AU of claim 15, wherein the AU does not support the first floating point data format for the tensor operation.

17. The AU of claim 15, wherein the one or more processor cores are configured to:
randomly generate a stochastic number;
combine the stochastic number with the scaled number to produce a combined number; and
truncate the combined number to produce the converted value.

18. The AU of claim 15, wherein the one or more processor cores are configured to:
convert the converted value from the second floating point data format to a third floating point data format that is higher in precision than the second floating point data format.

19. The AU of claim 15, wherein the one or more processor cores are configured to:
clamp a second value of the plurality of values to a predetermined value associated with the second floating point data format.

20. The AU of claim 15, wherein the AU is further configured to:
flush a second value of the plurality of values in response to the second value indicating a denormalized number.
